(19) United States
(12) Patent Application Publication
(10) Pub. No.: US 2008/0137854 A1
(43) Pub. Date: Jun. 12, 2008

(54) Secure data transmission utility system

(76) Inventor: Victor Bryan Friday, Tombell, TX (US)

Correspondence Address: Zecurity, LP, 31503 Capella Circle, Tomball, TX, 77375, US

(21) Appl. No.: 11/601,937

(22) Filed: Nov. 20, 2006

(51) Int. Cl. H04K 1/00

(52) U.S. Cl. 380/255

(57) ABSTRACT

A secure data transmission utility system which provides the ability to transmit any data from point A to point B across a data network or an Internet network without the possibility of being “hacked” is disclosed. The data being transmitted may be (but is not limited to) data such as digital, graphical, image, multi-media, stream or any other type of computing information. This utility system spans multiple media and computing device types. The data being transmitted is scrambled into unique pieces which constantly change structure and content between transmissions. The data being transmitted is also translated into randomly generated computer languages only decipherable by the secure data transmission utility system. The secure data transmission utility system also implements a series of one-way communications secured by controlled servers. The secure data transmission utility system is also scalable to any desired security level or computing application. The secure data transmission utility system can integrate with existing or new computing applications. The secure data transmission utility system will provide a new level of security for data transmissions in what is commonly called the Transport Layer, however, the secure data transmission utility system is not limited to only the Transport Layer but is applicable to any system or layer where a secure data transmission from point A to point B is required.

### FIELD OF INVENTION

This invention relates to secure data transmissions across networks or the internet. More specifically, this invention relates to a utility system which is able to transmit data across a network or the internet while keeping the transmitted data secure from unintended recognition and interpretation and at the same time being able to recognize and correctly interpret the data transmission at the intended receiving location.

### BACKGROUND OF INVENTION

With the explosion of the Internet in business, security has become great concern. Secure data transmissions are increasingly becoming a concern as new ways of intercepting data transmissions are growing. And, each day there seems to be another report of data being hacked. Businesses want the ability to use networks and the internet for more applications; however, they are forced to take calculated risks that their data won't be impacted by these intrusions. Malicious harm is a serious threat when data transmission security is compromised.

Current Transport Layer Security solutions are inadequate because they are based on the premise that computer security can be solved in the same manner as it has been attempted in the past. Current solutions such as encryption, generated keys, etc. do not solve core issues because of problems related to continuous connectivity, a software solution mandate, and the lack of individual accountability.

Continuous connectivity is the ability to access computing systems through a constant two-way connection. There are multiple security risks present when there is the capability of sending a command to a computer and have it respond to the originating location. Continuous connectivity is a problem recreated and exacerbated by the Internet because this problem was once solved in the 1980s by elaborate internal security systems. These internal security systems (which are still in use today) were designed and constructed to control access to files, networks and databases through granted privileges. These internal security systems worked effectively for those computing environments because access is controlled to these computing environments. Individual accountability is established when a user accesses the computing environment. However, the Internet by design has no central authority to determine individual authority and therefore individual accountability on the Internet is either not required or it may be effectively masked. Consequently, continuous connectivity has now resurfaced as a paramount security problem, which must again be addressed.

The software mandate is the incessant approach by security solutions providers to use software only to solve computing security for the Internet. The problem is that software is based on math or logic, which works the same for the hacker as it does the entity trying to secure their data transmissions. For example, when the industry uses encryption/decryption techniques, the original data to be transmitted is present in the data transmission only in a different mathematical form. These mathematical formulas can be hacked.

The lack of ability to establish individual accountability coupled with the continuous connectivity makes software alone as insufficient to solve these issues. No firewall (which is software), or encryption software is ever able to be entirely capable of securing information because such software may eventually be circumvented by other software. Thus, there exists a need for secure data transmissions in networks and the internet.

There is a need for a secure data transmission utility system which uses multiple components to achieve the desired level of security during the data transmissions. These components need to consist of systems and mechanisms that will be used in the process to protect and transmit information securely to a desired location.

It is to be understood that both the foregoing general description and the following detailed description are not limiting but are intended to provide further explanation of the invention claimed. The accompanying drawings, which are incorporated in and constitute part of this specification, are included to illustrate and provide a further understanding of the method and system of the invention. Together with the description, the drawings serve to explain the principles of the invention.

### SUMMARY OF THE INVENTION

These needs may be addressed by the present invention, one aspect of which is a secure data transmission utility system for protecting data being transmitted between devices. The protection is provided by Unique Transport Codes (UTC(s)). The UTCs have randomly generated components and the UTCs are physically inaccessible to “hackers”. These properties keep the UTCs from being anticipated, or mathematically decoded. The UTCs also do not physically contain the original data transmission but rather they contain a randomly generated computer language which represents the original data transmission. Each data transmission uses a different UTC which is synchronized through data bases. It is also important to note that each aspect of the invention works in harmony with all of the other aspects to provide a secure data transmission utility.

Another aspect of the present invention is that the UTCs use a variable length on each data transmission which isolates each transmission to be its own contained data entity. Therefore, programs which try to decode data transmissions are unable to establish a pattern used for the transmissions.

Another aspect of the present invention is that the UTCs have a command structure which changes the locations of transmission instructions in the data transmissions. This also combats programs which try and decode data transmissions.

Another aspect of the present invention is the transmission data bases are protected by secure servers which physically prohibit intrusion and detection. Such servers have a combination of software and hardware which provides physical protection from unwanted intrusions. An example of a secure server can be referenced in U.S. Pat. No. 6,631,453 B1.

Another aspect of the present invention is that the data transmissions are scrambled into pieces so that there is not a consistent area in the data transmission package to hold the data to be transmitted. This also prohibits programs from decoding transmissions.

Another aspect of the present invention is that the data transmissions can be transmitted through different paths of a network making it difficult to actually intercept all pieces of a data transmission.

Another aspect of the present invention is that it has a small “footprint” and can be adapted to virtually any device which needs to transmit data securely.

Another aspect of the present invention is that encryption/decryption is rendered useless because encryption/decryption is based on mathematical keys and logic, where UTCs are not. UTCs are randomly generated synchronized transmission instructions for each data transmission. It is possible to use encryption/decryption in conjunction with the present invention; however, this would only be for deceptive purposes. Encryption/decryption is not part of the present invention as it is not capable of securing data. It is important to note a primary difference between this present invention and encryption/decryption techniques being, in this present invention the original data to be transmitted is never actually in the data transmission. However, encryption/decryption techniques still contain the original data to be transmitted, just in a different mathematical form.

Another aspect of the present invention is that the transmission data bases translate the data to be transmitted into unrelated data strings which actually travel in the data transmission. Once received at the target locations, the secure data transmission utility converts the unrelated data strings back to its original content. This aspect means that the actual data to be transmitted does not travel in the actual transmission. This further prohibits data from being decoded.

Another aspect of the present invention is the components of the UTC are randomly generated, thus, creating endless unrecognizable computer languages, which only the origination and destination locations understand.

Another aspect of the present invention is the UTC is not included in the data transmissions of the translated data content. This aspect disallows “hackers” from intercepting and attempting to decode a particular UTC.

Another aspect of the present invention is the UTC changes on each data transmission, so no two UTCs are alike.

Another aspect of the present invention is the ability to restart and recover from error situations of data transmissions.

Another aspect of the present invention is that the secure data transmission utility system can be integrated into existing systems or placed in newly developed systems. And, the present invention can be scaled to provide multiple layers of security by repeating components of the system. This will add more layers of complexity and further confuse entities wishing to decode the data transmissions.

It is to be understood that both the foregoing general description and the following detailed description are not limiting but are intended to provide further explanation of the invention claimed. The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF DRAWINGS

FIG. 1 is a block diagram of the secure data transmission utility system according to one embodiment of the present invention;

FIG. 2 is a block diagram of an alternate secure data transmission utility system according to another aspect of the present invention;

FIG. 3 is a flow diagram of the process-used to program the secure data transmission utility system in FIG. 2;

FIG. 4 is a diagram of the command tables and structures used for the secure data transmission utility system in FIG. 2;

FIG. 5 is a diagram of the command tables and structures used for the secure data transmission utility system in FIG. 2;

### DESCRIPTION OF THE PREFERRED EMBODIMENT

While the present invention is capable of embodiment in various forms, there is shown in the drawings and will hereinafter be described a presently preferred embodiment with the understanding that the present disclosure is to be considered as an exemplification of the invention, and is not intended to limit the invention to the specific embodiment illustrated.

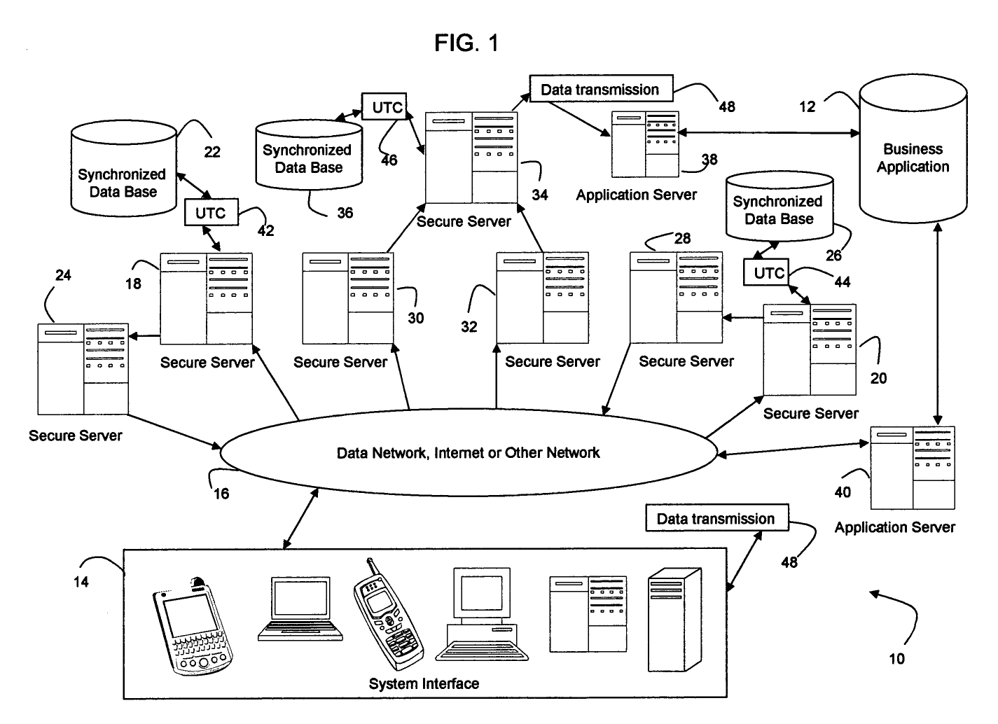

FIG. 1 is a block diagram of a secure data transmission utility system 10 according to the present invention. The secure data transfer system 10 provides a secure interface between a business application 12 and a system interface computing device 14. The system interface computing device 14 can be any number of different computing devices for personal and business use. In fact, the system interface computing device 14 can be any type of personal computing device, a mobile phone, a mobile personal device, an ATM machine, a debit or credit card device, a card reader, an optical scanner, a personal computer, a computing music or video device, a server, or a computing device inside any number of private or public business or pleasure computing devices or systems and can be used to process any information that is desired to be kept secure from recognition or intrusion. The connection between the system interface computing device 14 and the business application 12 is made through a data network 16. It is understood the data network 16 may be a hard wired network, a wireless network, a fiber optic network, a digital network, the internet, a private internet, a private network, a dedicated business network, a dedicated entertainment network, a dedicated pleasure network, or any advanced data network. The data transmission protocol for the system interface computing device 14 and the business application 12 and the data network 16 is any common standard connection. To make a secure transmission of data, the system interface computing device 14 sends a request for a unique transport code (UTC) to a secure server 18 and a secure server 20. The secure server 18 is only capable of reading requests from the system interface computing device 14 through the data network 16. The secure server 20 is only capable of reading requests from the system interface computing device 14 through the data network 16. The secure server 18 reads the UTC 42 from the synchronized data base 22 and passes the UTC 42 to the secure server 24. The secure server 24 is only capable of reading requests from secure server 18. The secure server 24 passes the UTC 42 back to the system interface computing device 14 through the data network 16. The secure server 20 is only capable of reading requests from the system interface computing device 14 through the data network 16. The secure server 20 reads the UTC 44 from the synchronized data base 26 and passes the UTC 44 to the secure server 28. The secure server 28 is only capable of reading requests from secure server 20. The secure server 28 passes the UTC 44 back to the system interface computing device 14 through the data network 16. The system interface computing device 14 receives the UTC 42 from the secure server 24 and passes the data transmission 48 to be secured to the secure server 30 according to the instructions contained the in UTC 42. The system interface computing device 14 receives the UTC 44 from the secure server 28 and passes the data transmission 48 to be secured to the secure server 32 according to the instructions contained in the UTC 44. The secure server 30 and the secure server 32 are only capable of reading requests from the system interface computing device 14. The secure server 30 and the secure server 32 pass the data transmission 48 to the secure server 34 which is only capable of reading transmissions from the secure server 30 and the secure server 32. The secure server 34 reads the synchronized data base 36 and reassembles the data transmission 48 according to the instructions contained in the UTC 46. The secure server 34 then passes the desired data transmission 48 to the application server 38. The application server 38 then passes the data transmission 48 to the destination business application 12. The business application 12 then communicates a confirmation of transmission through the application server 40 to the system interface computing device 14 through the data network 16. It should be noted that the business application 12, the application server 38, and the application server 40 can be configured differently depending on the destination location application. It should be noted that the secure server 18, the secure server 24, the secure server 30, the secure server 34, the synchronized data base 22, and the synchronized data base 36 work as a unit and can be repeated in this utility system as many times as desired for increased levels of security. Thereby, this solution is scaleable to the needs of the application. It is also possible that the synchronized data base 22 and the synchronized data base 36 could actually be the same data base depending on the desired level of security. UTC 42, UTC 44, and UTC 46 consist of unique randomly generated parts consisting of entry keys, structure definitions, translations of data codes, breakdown instructions, synchronization codes, instruction definitions, timing codes, and order definitions. UTCs will also contain computer generated languages and instructions only decipherable by the synchronized data base 22, synchronized data base 26, and synchronized data base 36. The secure server 18, secure server 20, secure server 24, secure server 28, secure server 30, secure server 32, and secure server 34 have hardware controlled firmware which makes them only capable of their desired function. This controlled firmware provides the necessary ingredient to prohibit intrusion into the synchronized data base 22, synchronized data base 26, and synchronized data base 36.

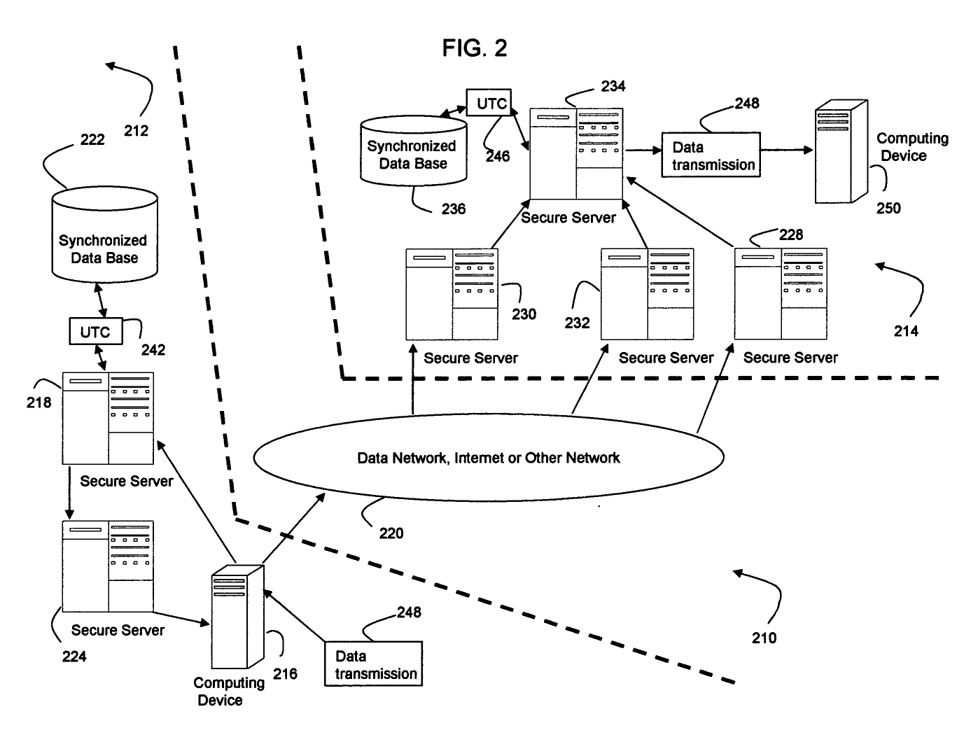

FIG. 2 is a block diagram of a secure data transmission utility system 210 according to the present invention. The secure data transfer system 210 provides a secure interface between the physical location 212 and the physical location 214, thus providing a secure interface between computing device 216 and computing device 250. Computing device 216 and the computing device 250 can be any number of different computing devices for personal, entertainment and business use. The connection between computing device 216 and the computing device 250 is made through a data network 220. It is understood the data network 220 may be a hard wired network, a wireless network, a fiber optic network, a digital network, the internet, a private internet, a private network, a dedicated business network, a dedicated entertainment network, a dedicated pleasure network, or any advanced data network. The data transmission protocol for computing device 216 and the computing device 250 and the data network 220 is any common standard connection.

To make a secure transmission of data, the computing device 216 sends a request for a unique transport code (UTC) to a secure server 218. Secure server 218 is only capable of reading requests from the computing device 216. Secure server 218 reads the UTC 242 from the synchronized data base 222 and passes the UTC 242 to the secure server 224. Secure server 224 is only capable of reading requests from secure server 218. Secure server 224 passes the UTC 242 back to the computing device 216. Computing device 216 receives the UTC 242 from the secure server 224 and passes the data transmission 248 to be secured according to the instructions contained the UTC 242. The data transmission 248 can be any information that is wanted to be kept secure from outside intrusion, including but not limited to, medical records, legal records, or financial information.

Computing device 216 transmits the secure transmission to a single or multiple locations connected to the data network 220 depending on the instructions in UTC 242. In this diagram, the data transmission is broken up into different pieces and each piece is sent to the secure server 230, secure server 232, and secure server 228. Secure server 230, secure server 232, and secure server 228 are only capable of reading requests from computing device 216. Secure server 230, secure server 232, and secure server 228 pass their portions of the data transmission 248 to secure server 234. Secure server 234 is only capable of reading requests from secure server 230, secure server 232, and secure server 228.

The secure server 234 reads the synchronized data base 236 and reassembles the data transmission 248 according to the instructions contained in UTC 246. In this diagram, UTC 242 and UTC 246 are synchronized and work in conjunction with one another to breakdown, translate, and reassemble the data transmission 248. Secure server 234 then passes the desired data transmission 248 to the computing device 250.

It should be noted that the number of receiving secure servers are scaleable, such as secure server 230, secure server 232, and secure server 228 and can be altered in the configuration to fit the business need. It should also be noted that UTC 242 and UTC 246 consist of unique randomly generated parts consisting of entry keys, structure definitions, translations of data codes, breakdown instructions, synchronization codes, instruction definitions, timing codes, and order definitions. And, UTC 242 and UTC 246 will also contain computer generated languages and instructions only decipherable by the synchronized data base 222 and synchronized data base 236. It should also be noted that the secure server 218, secure server 224, secure server 230, secure server 232, and secure server 228, and secure server 234 have hardware controlled firmware which makes them only capable of their desired function. This controlled firmware provides the necessary ingredient to prohibit intrusion into the synchronized data base 222 and synchronized data base 236.

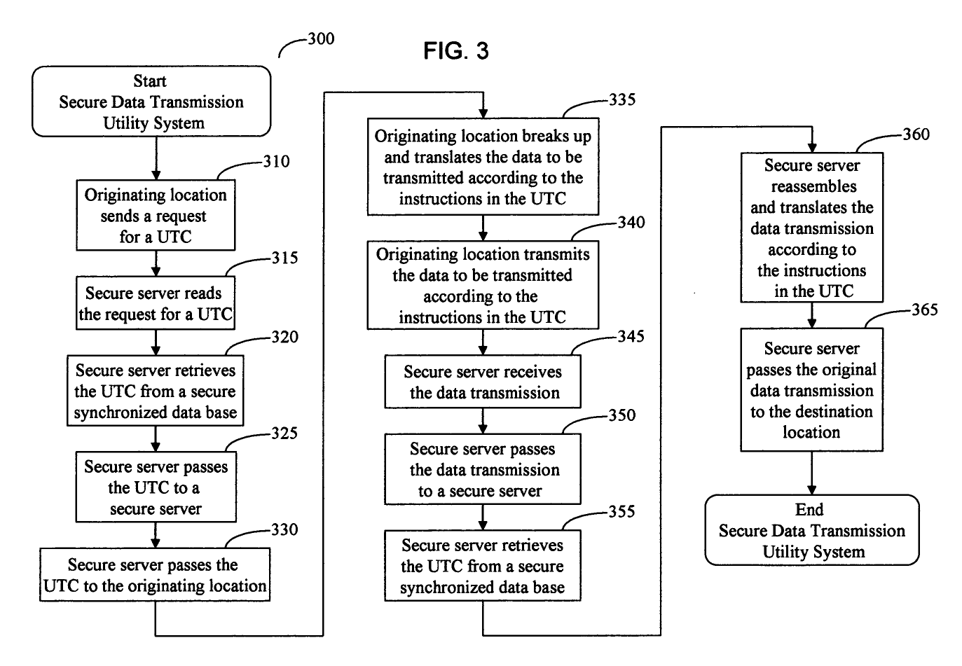

FIG. 3 is a software flowchart of the logical operations of the secure data transmission utility system 300. These declarations show the logic used to operate the secure data transmission utility system 300 similar to the system shown in FIG. 2.

The secure data transmission utility system 300 sends a request for a unique transport code (UTC) in step 310. A secure server reads the request for a UTC in step 315. The secure server retrieves the UTC from a secure synchronized data base in step 320. The secure server then sends the UTC to a separate server in step 325. In step 330, the second secure server passes the UTC back to the originating location.

In step 335, the originating location breaks up and translates the data to be transmitted according to the instructions in the UTC. The secure data transmission utility system 300 then transmits the data to be transmitted according to the instructions in the UTC in step 340.

In step 345, the receiving secure server receives the data transmission. It is important to note that there may be multiple receiving secure servers. The secure server(s) then pass the data transmission to another secure server in step 350. The secure server then retrieves a synchronized UTC from a second secure synchronized data base in step 355. The secure server then reassembles and translates the data transmission according to the instructions in the UTC in step 360. The secure server then passes the original data transmission to the destination location in step 365.

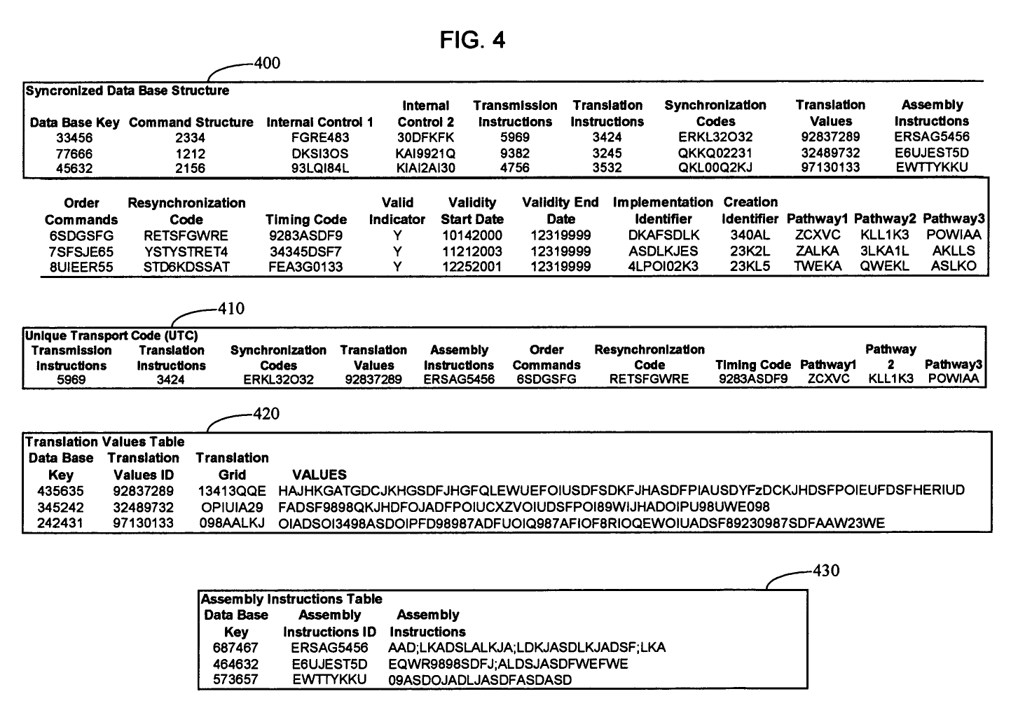

FIG. 4 is an example of a Synchronized Data Base Structure 400, a Unique Transport Code (UTC) 410, a Translations Value Table 420, and an Assembly Instructions Table 430 used in the secure data transmission utility system. The tables 400, 410, 420, and 430 represent four of the files necessary to house the configuration logic to direct the execution paths of logic of the present invention. The Synchronized Data Base Structure 400 is used to coordinate between the sending and receiving servers with commands and instructions detailing how to breakup and reassemble the data transmissions, where to transmit the data for the data transmission, what values to assign to the data contents in the data transmission, which transmission synchronization codes are valid, the particular order data transmissions are to be handled, and the resynchronization code if needed for error recovery in a data transmission. In addition, the Synchronized Data Base Structure 400 keeps track of when data base records were generated, implementation information, and validity periods for each record.

The primary information exchange occurs through the Unique Transport Code (UTC) 410 in the present invention. The UTC 410 is used to pass essential information to instruct a receiving location on how to transmit the data in the data transmission. It is important to note that the contents of the UTC 410 are randomly generated using a standard random number generator prior to the data transmission. This random generation of UTC 410 contents prohibits intruders from intercepting and anticipating data transmission patterns, eliminating unwanted intrusion. It is also important to note the Values in the Translation Values Table 420 provides the data necessary to cause the change of the original data content to unrelated randomly generated values on each data transmission, and this action by the present invention provides an impenetrable means for a data transmission. Also, this action differentiates itself from other encryption/decryption techniques because the original data content is never in the data transmission. And, because the Synchronized Data Base Structure 400 is protected by secure servers, prior access to UTC information is impossible.

The Assembly Instructions Table 430 provides the detail needed to break apart the original data transmission into uneven pieces so that pattern recognition software is rendered useless because the sizes and number of pieces vary on each data transmission. Each piece of the data transmission will be sent to different receiving secure servers.

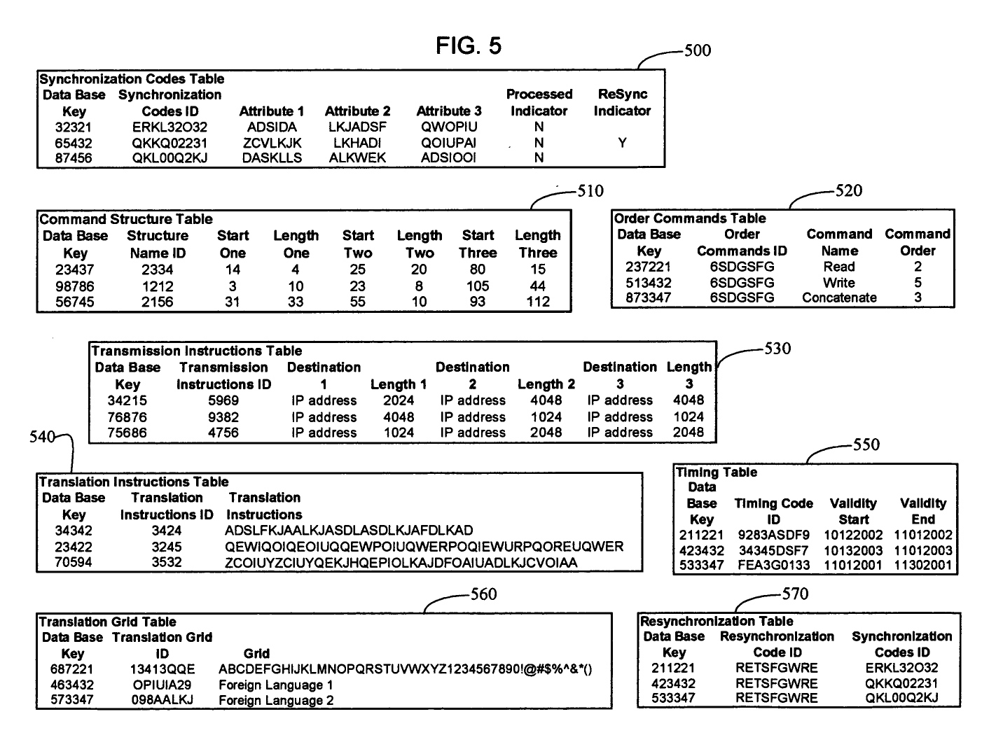

FIG. 5 is an example of a Synchronization Codes Table 500, a Command Structure Table 510, an Order Commands Table 520, a Transmission Instructions Table 530, a Translations Instructions Table 540, a Timing Table 550, a Translation Grid Table 560, and a Resynchronization Table 570 used in the present invention. The tables 500, 510, 520, 530, 540, 550, 560, and 570 represent eight of the files necessary to house the configuration logic to direct the execution paths of logic of the present invention.

The Synchronization Codes Table 500 provides the necessary detail for the synchronization codes used in the data transmissions. These values provide a means of checking the synchronization codes for validity. This action will prohibit intruders from sending unwanted data transmissions through the present invention. The values in the Synchronization Codes Table 500 are randomly generated which disables data pattern recognition intrusions.

The Command Structure Table 510 provides the necessary detail to alter the commands used in the data transmissions. This activity allows for commands to vary in length in the data transmissions to further disable data pattern recognition intrusions. These values are also randomly generated. Similarly, the Order Commands Table 520 provides the necessary detail to alter the order of commands used in the data transmissions. These values, randomly generated, further disable data pattern recognition intrusions.

The Transmission Instructions Table 530 provides the information necessary to instruct where data transmissions will actually be transmitted according to the implementation of the present invention. These locations will be randomly generated and will vary on each of the data transmissions to further prohibit data recognition of the data transmissions.

The Translations Instructions Table 540 allows for the altering of how to alter the original data transmission into an unrelated randomly generated form. By changing how the Translation Instructions function on each data transmission, data recognition patterns of commands is rendered useless. Also, these instructions are randomly generated.

The Timing Table 550 provides the necessary detail to add a timing feature to the data transmissions which will enable further validity checking of the data transmissions and prohibit unauthorized intrusion through the means of a fake data transmission.

The Translation Grid Table 560 further enables the present invention to alter the original data transmission through an unpredictable logic path. This functionality further disables data pattern recognition intrusion methods.

The Resynchronization Table 570 will allow a data transmission to recover from an unanticipated error situation by providing a resynchronization code. This functionality will enable the present invention to continue to function in a consistent, dependable manner.

It will be apparent to those skilled in the art that various modifications and variations can be made in the method and system of the present invention without departing from the spirit or scope of the invention. Thus, the present invention is not limited by the foregoing descriptions but is intended to cover all modifications and variations that come within the scope of the spirit of the invention and the claims that follow.

What is claimed is:

1. A secure data transmission utility system for transmitting data between computing devices, the secure data transmission utility system comprising;
an originating computing device coupled to a data transmission or local network capable of receiving data and sending data;
a sequence of one or multiple secure servers coupled to the originating computing device through a data transmission or local network capable of receiving data from the originating computing device;
a synchronized secure data base coupled to the sequence of one or multiple secure servers capable of retrieving, storing, and writing data to the sequence of one or multiple secure servers;
a unique transport code stored in the synchronized secure data base capable of providing sending commands and instructions for the data content transmission;
a secure server coupled to the sequence of one or multiple secure servers and the originating computing device through a data transmission or local network capable of receiving data from the sequence of one or multiple secure servers and sending data to the originating computing device;
a second sequence of one or multiple secure servers coupled to a data transmission or local network capable of receiving a transmission of data content from the originating computing device;
a secure server coupled to the second sequence of one or multiple secure servers capable of receiving data from the second sequence of one or multiple secure servers and writing data to a destination computing device or an application server;
a synchronized secure data base coupled to a secure server capable of retrieving, storing, and writing data to a secure server;
a unique transport code stored in the synchronized secure data base capable of providing receiving commands and instructions for the data content transmission;
a destination computing device or application server coupled to a secure server capable of receiving a transmission of data content from the secure server.

2. The system in claim 1 wherein the originating computing device is a computing device requiring a secure data transmission.

3. The system in claim 2 wherein the originating computing device contains data content that will be transmitted to the destination computing device or application server.

4. The system in claim 3 wherein the originating computing device is coupled to a data transmission or local network through any standard computing connections.

5. The system in claim 4 wherein the originating computing device uses any standard storage media.

6. The system in claim 5 wherein the originating computing device is capable of executing programs which allows it to request a unique transport code.

7. The system in claim 6 wherein the originating computing device is capable of deciphering and executing the instructions of the unique transport code.

8. The system in claim 7 wherein the originating computing device is capable of transmitting the data content to the destination computing device or application server.

9. The system in claim 1 wherein the secure servers have a combination of hardware and software functionality which provides the secure servers functionality and security, the secure servers having the capability:
of reading requests for unique transport codes;
of retrieving the unique transport code from a synchronized secure data base;
of passing the unique transport code to another secure server;
of passing the unique transport code to the originating computing device;
of passing the data transmission to the destination computing device.

10. The system in claim 1 wherein a synchronized secure data base uses an organized file management system, the synchronized secure data base comprising:
a set of two or multiple storage locations for the unique transport code;
a set of two or multiple locations for the storage of commands and structures needed to process the data transmissions;
a replicated storage location to correspond to the originating computing device and the destination computing device or application server.

11. The system in claim 1 wherein the unique transport code is stored in the synchronized secure data base, the unique transport code comprising:
a set of randomly generated translation instructions which translate and remove the original data content from the data transmission;
a structure containing variable length structures for data field contents;
a structure of variable command structures for the instructions of the data transmission;
a set of randomly generated instructions to disassemble, transmit, and reassemble data transmissions in variable length pieces;
a set of instructions to transmit data to multiple and varying receiving locations;
a structure of randomly generated unrecognizable computer languages which replace the original data content in the data transmission;
a set of error recovery instructions to be executed in the event of an error in the data transmission process.

12. The system in claim 11 where in the unique transport code is generated prior to the transmission of the data content.

13. The system in claim 12 wherein the unique transport code is synchronized between the originating computing device and the destination computing device by the replication of the synchronized secure data base.

14. The system in claim 13 wherein the unique transport code is physically inaccessible from outside intrusion by the security of the secure servers.

15. The system in claim 14 wherein the unique transport code changes on each data transmission.

16. The system in claim 15 wherein the unique transport code is absent from the data transmission of the data content.

17. A method of transmitting original data content from the originating computing device to the destination computing device or application server, the method comprising:
an originating computing device sends a request for a unique transport code to a sequence of one or multiple secure servers;
a sequence of one or multiple secure servers reads the request for the unique transport code;
a sequence of one or multiple secure servers retrieves the unique transport code from a synchronized secure data base;
a sequence of one or multiple secure servers passes the unique transport code to a secure server;
a secure server passes the unique transport code to the originating computing device.

18. The method in claim 17 further comprising:
an originating computing device receives the unique transport code from the secure server;
an originating computing device deciphers the order of the commands in the unique transport code;
an originating computing device deciphers the command structure in the unique transport code;
an originating computing device executes the command to assemble the data content into the correct variable length pieces for transmission;
an originating computing device deciphers the translation instructions in the unique transport code;
an originating computing device removes the original data content from the data transmissions by using the translation values in the unique transport code;
an originating computing device deciphers the transmission instructions in the unique transport code;
an originating computing device transmits the data transmissions to the receiving a sequence of one or multiple secure servers through a data transmission or local network.

19. The method in claim 17 further comprising:
a sequence of one or multiple secure servers receives the data transmissions from the originating computing device through a data transmission or local network;
a sequence of one or multiple secure servers passes the data transmissions to a secure server;
a secure server retrieves the unique transport code from a synchronized secure data base;
a secure server verifies the timing codes and synchronization codes in the data transmissions;
a secure server deciphers the order of the commands in the unique transport code;
a secure server deciphers the command structure in the unique transport code;
a secure server deciphers the translation instructions in the unique transport code;
a secure server replaces the original data content into the data transmissions by using the translation values in the unique transport code;
a secure server executes the command to assemble the data content into the correct format;
a secure server passes the original data content to a destination computing device or application server.

20. A computing system for the secure transmission of data, the system comprising:
an originating computing device;
a set of synchronized secure data bases protected from intrusion by secure servers;
a sequence of one or multiple secure servers which derive their security from a combination of hardware and software;
a set of unique transport codes made up of previously randomly generated components;
a destination computing device or application server;
a method of variable command structures contained in the unique transport code;
a method of varying the size of the data transmissions;
a method of varying the destination locations of the data transmissions;
a method of recovering from errors in data transmissions;
a method of translating original data content to unrelated unrecognizable computing data languages to remove the original data content from any visible data transmissions;
a method of inserting original data content back into the data transmission once it has been received at the destination location.
